(19) United States
(12) Patent Application Publication
(10) Pub. No.: US 2026/0148140 A1
(43) Pub. Date: May 28, 2026

(54) SYSTEMS AND METHODS FOR PERFORMING SYMBOLIC REGRESSION

(71) Applicant: Ohio State Innovation Foundation, Columbus, OH (US)

(72) Inventors: Madhav Reddy Muthyala, Columbus, OH (US); Joel Paulson, Columbus, OH (US); Farshud Sorourifar, Columbus, OH (US)

(21) Appl. No.: 19/397,342

(22) Filed: Nov. 21, 2025

Related U.S. Application Data
(60) Provisional application No. 63/723,938, filed on Nov. 22, 2024.

(51) Int. Cl. G06N 20/00

(52) U.S. Cl. CPC G06N 20/00

(57) ABSTRACT

A method for modeling data, the method including: receiving a dataset including a number of input sets and a number of outputs each corresponding to an input set of the number of input sets, wherein the number of input sets are related to the number of outputs by a function; receiving an operator set including at least one of (i) an algebraic operator, (ii) a transcendental function, (iii) a constant function, or (iv) an identity function; reducing the dataset by removing an input from an input set of the number of input sets to produce a reduced dataset; generating, based on the reduced dataset, an expanded feature set; generating, based on the expanded feature set and a complexity parameter, a set of models, wherein each model of the set of models is associated with a complexity value and a loss value; and updating the complexity parameter and the expanded feature set.

### CROSS-REFERENCE TO RELATED APPLICATIONS

This application claims the benefit of U.S. Provisional Patent Application No. 63/723,938, filed on Nov. 22, 2024, the entire contents of which are incorporated herein by reference.

### STATEMENT REGARDING FEDERALLY SPONSORED RESEARCH OR DEVELOPMENT

This invention was made with government support under 2237616, awarded by the National Science Foundation. The government has certain rights in the invention.

### BACKGROUND

The present disclosure relates generally to the field of machine learning, and more specifically to systems and methods for performing symbolic regression. Symbolic regression may be useful for generating mathematical expressions that describe a dataset.

### SUMMARY

In some aspects, the techniques described herein relate to a method for modeling data, the method including: receiving a dataset including a number of input sets and a number of outputs each corresponding to an input set of the number of input sets, wherein the number of input sets are related to the number of outputs by a function; receiving an operator set including at least one of (i) an algebraic operator, (ii) a transcendental function, (iii) a constant function, or (iv) an identity function; reducing the dataset by removing an input from an input set of the number of input sets to produce a reduced dataset; generating, based on the reduced dataset, an expanded feature set; generating, based on the expanded feature set and a complexity parameter, a set of models, wherein each model of the set of models is associated with a complexity value and a loss value; and updating the complexity parameter and the expanded feature set.

In some aspects, the techniques described herein relate to a method, wherein reducing the dataset includes computing:

$$MI ( y ; {x}_{i} ) = \int p ( {x}_{i} , y ) log ( \frac{p ( {x}_{i} , y )}{p ( {x}_{i} ) p ( y )} ) dxdy$$

where p(xᵢ,y) is a joint probability density function between the input set (xᵢ) and an output (y) corresponding to the input set, p(xᵢ) is a marginal distribution for the input set (xᵢ), and p(y) is a marginal distribution for the output (y).

In some aspects, the techniques described herein relate to a method, further including generating, based on the set of models, a Pareto frontier with respect to the complexity value and the loss value associated with each model of the set of models. In some aspects, the techniques described herein relate to a method, further including: identifying a Pareto frontier from a number of Pareto frontiers, wherein the identified Pareto frontier is closer to utopia than any other Pareto frontier of the number of Pareto frontiers; and transmitting a set of models associated with the identified Pareto frontier. In some aspects, the techniques described herein relate to a method, further including iteratively updating the complexity parameter and the expanded feature set until a condition associated with the Pareto frontier has been satisfied. In some aspects, the techniques described herein relate to a method, wherein the complexity parameter is updated based on at least one of the complexity value or the loss value associated with each model of the set of models. In some aspects, the techniques described herein relate to a method, wherein the expanded feature set is updated based on at least one of the complexity value or the loss value associated with each model of the set of models.

### BRIEF DESCRIPTION OF THE DRAWINGS

The above and other aspects and features of the present disclosure will become more apparent to those skilled in the art from the following detailed description of the example embodiments with reference to the accompanying drawings.

FIG. 1 is a flowchart illustrating a method for modeling data, according to an exemplary embodiment.

FIG. 2 is a block diagram of a computer system, according to an exemplary embodiment.

FIG. 3 is a diagram illustrating the method of FIG. 1, according to an exemplary embodiment.

FIG. 4 is a diagram illustrating a method of generating a symbolic expression for a set of tested models, according to an exemplary embodiment.

### DETAILED DESCRIPTION

Referring generally to the FIGURES, described herein are systems and methods for modeling data. In many contexts, it may be useful and/or desirable to determine a model, such as a mathematical model/relationship/function, that describes a dataset. For example, it may be useful to determine a mathematical function that describes a medical dataset that includes patient characteristics (e.g., blood pressure, weight, preexisting conditions, family history, income, etc.) and patient outcomes. To continue the example, once obtained, the mathematical relationship may be useful in determining which patient characteristics have the greatest impact on patient outcomes. Determining a mathematical function that describes a dataset may be referred to as “symbolic regression” (SR).

Systems and methods of the present disclosure relate to improved methods of symbolic regression that may solve limitations associated with conventional systems and methods. For example, conventional systems may suffer from: (i) high computational costs, (ii) an inability to handle a large number of input dimensions, (iii) an inability to handle noise, and/or (iv) an inability to generate an accurate model that is also simple. More specifically, conventional methods of symbolic regression may be resource intensive (e.g., require large amounts of compute, power, etc.). For example, conventional methods may suffer from “bloat” in which they generate overly complex models to describe an underlying dataset, thereby making such methods impractical for large datasets or complex systems (e.g., due to computational cost). Additionally, conventional systems may only be suitable for determining simple (i.e., highly linear) relationships. Systems and methods of the present disclosure may overcome one or more of these limitations by facilitating symbolic regression for complex (i.e., highly nonlinear) systems in a manner that balances accuracy and complexity while remaining computationally compact. For example, systems and methods of the present disclosure may reduce the amount of compute required to model a system while increasing the accuracy the generated model (e.g., such that the generated model may have a higher prediction accuracy than models generated using the same amount of compute via conventional systems/methods, etc.).

In various embodiments, systems and methods of the present disclosure facilitate one or more of (i) automated feature screening (e.g., pruning a primary feature space before recursive feature expansion, thereby improving an ability to scale to datasets with a large number of inputs, etc.), (ii) generating an information-theoretic complexity measure (e.g., that accounts for the number and type of operations performed, etc.), (iii) constructing a Pareto frontier (e.g., to evaluate tradeoffs between model complexity and predictive performance, etc.), and/or (iv) automated hyperparameter tuning (e.g., tuning hyperparameters such as sparsity levels, generated feature space, complexity constraint bound, screening thresholds, and/or the like, etc.). For example, systems and methods of the present disclosure may facilitate sequentially testing combinations of hyperparameters, determining a Pareto front between loss and complexity for each combination, and updating the hyperparameter values based on the determined Pareto front. In some embodiments, systems and methods of the present disclosure facilitate mutual information-based screening (e.g., to reduce a computational cost and/or memory required to model a system, etc.).

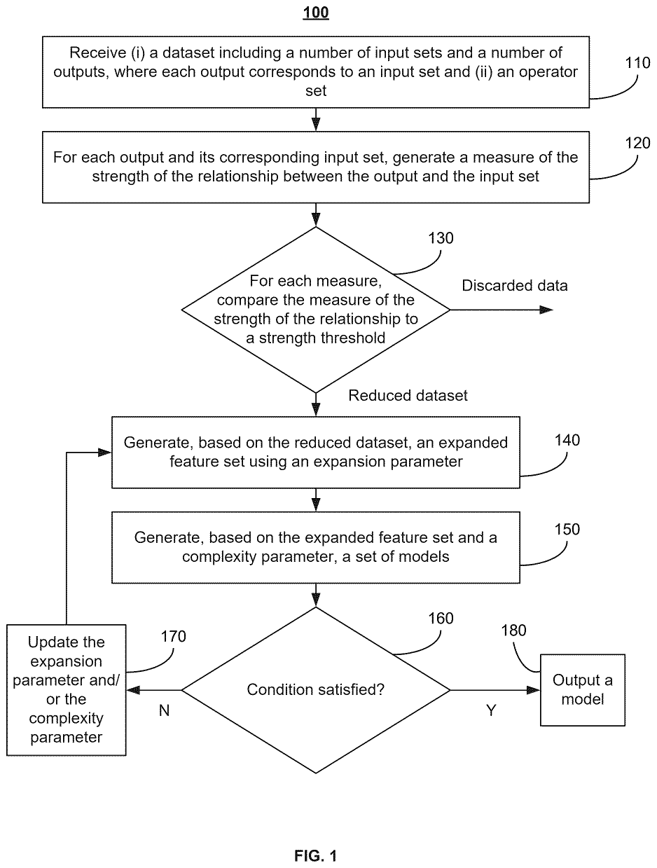

Referring now to FIG. 1, method 100 for modeling data is shown, according to an exemplary embodiment. At step 110, method 100 may include receiving a dataset and an operator set. In various embodiments, the dataset includes a number of input sets, each corresponding to an output (e.g., several (xᵢ, yᵢ) pairs). Each input set may include one or more inputs. In various embodiments, the number of input sets are related to the outputs by an underlying function. Method 100 may discover and/or approximate the underlying function. In some embodiments, step 110 includes generating the operator set.

At step 120, method 100 may include generating a measure of the strength of the relationship between an output and its corresponding input set. In various embodiments, step 120 is performed for every [input set, output] combination.

At step 130, method 100 may include comparing the measure of the strength of the relationship between the output and its corresponding input set to a strength threshold. In various embodiments, step 130 is performed for every measure (e.g., the measure associated with each [input set, output] combination). If the strength satisfies the strength threshold, then step 130 may include retaining the feature (e.g., an xᵢ value of the (xᵢ,y) pairs). If the strength does not satisfy the strength threshold, then step 130 may include discarding the feature. In various embodiments, the result of step 130 is a reduced dataset (i.e., a reduced feature set). In some embodiments, step 130 includes additional refinements. For example, step 130 may include limiting the dataset/feature set to a predetermined size.

At step 140, method 100 may include generating, based on the reduced dataset, an expanded feature set using an expansion parameter.

At step 150, method 100 may include generating, based on the expanded feature set and a complexity parameter, a set of models. In various embodiments, each model is associated with a complexity value and/or a loss value. In various embodiments, the set of models forms a Pareto frontier based on the complexity values and the loss values.

At step 160, method 100 may include determining whether one or more conditions are satisfied. For example, step 160 may determine whether a maximum expansion value has been reached and whether a maximum complexity measure has been reached. If the condition(s) are satisfied, then method 100 may include outputting the model (i.e., step 180). In various embodiments, step 180 includes outputting a set of models that form a Pareto frontier. For example, step 180 may include outputting a number of models that form a Pareto frontier with respect to a measure of complexity and a measure of loss and identifying the model that is closest to the utopia point (e.g., the origin). If one or more condition(s) are not met, then method 100 may include updating the expansion parameter and/or the complexity parameter (i.e., step 170). In various embodiments, steps 140-170 continue until method 100 produces a model that satisfies the one or more conditions.

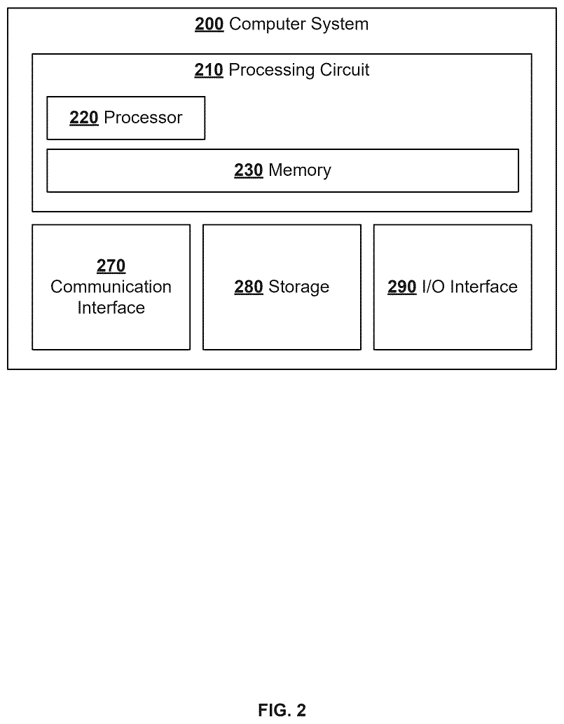

Referring now to FIG. 2, a block diagram of computer system 200 is shown, according to an exemplary embodiment. In various embodiments, computer system 200 models data as described herein. For example, computer system 200 may be used to perform method 100. Computer system 200 may include processing circuit 210, communication interface 270 and/or storage 280. Processing circuit 210 may include processor 220 and/or memory 230. Processor 220 may be a general purpose or specific purpose processor, an application specific integrated circuit (ASIC), one or more field programmable gate arrays (FPGAs), a group of processing components, or other suitable processing components. Processor 220 is configured to execute computer code or instructions stored in memory 230 or received from other computer readable media (e.g., CDROM, network storage, a remote server, etc.). Memory 230 may include one or more devices (e.g., memory units, memory devices, storage devices, and/or other computer-readable media) for storing data and/or computer code for completing and/or facilitating the various processes described in the present disclosure. Memory 230 may include random access memory (RAM), read-only memory (ROM), hard drive storage, temporary storage, non-volatile memory, flash memory, optical memory, or any other suitable memory for storing software objects and/or computer instructions. Memory 230 may include database components, object code components, script components, or any other type of information structure for supporting the various activities and information structures described in the present disclosure. Memory 230 may be communicably connected to processor 220 via processing circuit 210 and may include computer code for executing (e.g., by processor 220) one or more of the processes described herein. For example, memory 230 may have instructions stored thereon that, when executed by processor 220, cause processing circuit 210 to (i) receive training data (e.g., in the form of several (xᵢ, yᵢ) pairs) and/or a user-defined operator set, (ii) perform a mutual information pre-screening method to generate a limited featured set, (iii) iteratively expand the limited feature set (e.g., over a number of levels l) to produce an expanded feature set, (iv) generate, using the expanded feature set and a complexity parameter (λ_{c}), a set of test models M, where each model is associated with a loss value (L) and complexity value (C), and (v) iteratively improve a Pareto front associated with the test models by updating the number of levels l and the complexity parameter λ_{c} based on the loss value L and the complexity value C and repeating steps (iii)-(iv). In various embodiments, computer system 200 implements/is compatible with computational acceleration features such as tensor computing via GPUs (e.g., as implemented in PyTorch, etc.).

Communication interface 270 may facilitate communication with one or more systems/devices. For example, computer system 200 may communicate with a server via communication interface 270 (e.g., to receive a dataset, etc.). Communication interface 270 may be or include wired or wireless communications interfaces (e.g., jacks, antennas, transmitters, receivers, transceivers, wire terminals, etc.) for conducting data communications with external systems or devices. In various embodiments, communications via communication interface 270 is direct (e.g., local wired or wireless communications). Additionally or alternatively, communications via communication interface 270 may utilize a network (e.g., a WAN, the Internet, a cellular network, etc.).

Storage 280 may store data associated with the methods described herein. For example, storage 280 may store a received dataset. As another example, storage 280 may store a model generated to describe a dataset. In some embodiments, storage 280 stores timeseries data. Storage 280 may be or include one or more memory devices (e.g., hard drive storage, temporary storage, non-volatile memory, flash memory, optical memory, and/or any other suitable memory device).

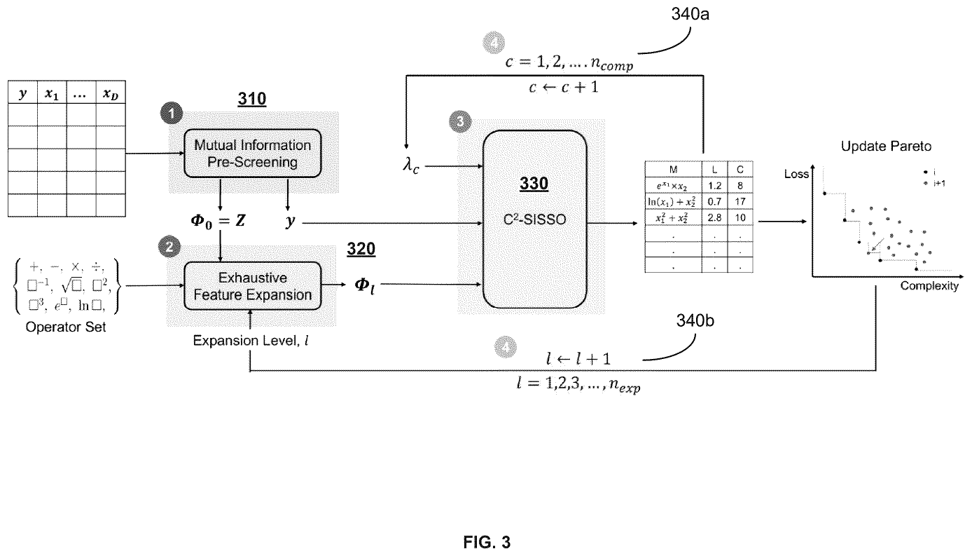

Referring now to FIG. 3, method 300 for modeling data is shown, according to an exemplary embodiment.

In various embodiments, method 300 includes determining a model (ƒ*) given a training data set D, according to:

$${f}^{*} = arg {min}_{f ∈ ℱ} L ( f ) = \frac{1}{n} {\sum }_{i = 1}^{n} l ( f ( {x}_{i} ) , {y}_{i} )$$

where

$$𝒟 = {\{ ( {x}_{i} , {y}_{i} ) \}}_{i = 1}^{n}$$

includes input xᵢ=(x_{1,i}, . . . , x_{D,i})∈ [symbol] ^{D} and scalar output yᵢ∈ [symbol] , [symbol] includes valid functions/mappings ƒ: [symbol] ^{D}→ [symbol] , l(·) is the loss function, and L(·) is the expected loss (e.g., empirical risk, etc.) measure. In some embodiments, the loss function is and/or includes a negative log-likelihood (NLL). In some embodiments, the loss is the mean squared error (MSE) (i.e., l(ƒ(xᵢ), yᵢ)=(yᵢ−ƒ(xᵢ))²). In various embodiments, [symbol] includes all functions that can be formed by composition of the elements of the primitive set [symbol] , which may include (i) algebraic operations (e.g., addition, subtraction, etc.), (ii) transcendental functions (e.g., sine, cosine, and exponential, etc.), (iii) constant functions (e.g., cₐ(x)=a for some a∈ [symbol] , etc.), and/or (iv) identity functions (e.g., l₁(x)=x₁ and l₂(x)=x₂, etc.). For example, [symbol] ={+(·,·),−(·,·),×(·,·),x₁, x₂,+1, −1} denotes that [symbol] includes the set of all two-dimensional polynomials of arbitrary degree in x₁ and x₂ with integer coefficients various embodiments, ƒ* is an optimal model that produces the lowest average loss across training data. In various embodiments, method 300 includes determining ƒ* such that ƒ* remains minimal for new observations that are not part of the training data set. For example, method 300 may include identifying a function ƒ that jointly minimizes (or reduces) an expected loss measure L(ƒ) and a measure of function complexity C(ƒ) (e.g., generating Pareto optimal functions defined such that no other function in [symbol] is less complex and more accurate, etc.).

At step 310, method 300 may include mutual information-based feature prescreening. In various embodiments, step 310 limits the number of primary features x that are used during feature expansion. In various embodiments, step 310 includes determining a mutual information (MI) metric to measure the strength of the relationship between a given component xᵢ and target y:

$$MI ( y ; {x}_{i} ) = \int p ( {x}_{i} , y ) log ( \frac{p ( {x}_{i} , y )}{p ( {x}_{i} ) p ( y )} ) dxdy$$

where p(xᵢ,y) is the joint probability density function between variables xᵢ and y and p(xᵢ) and p(y) are the corresponding marginal distributions. In various embodiments, step 310 includes ranking features according to the MI values by computing mᵢ=MI(y; xᵢ) for all i=1, . . . , D and then applying the Argsort operator to these values to determine the indices sorting the vector m=(mᵢ, . . . , m_{D}) in descending order. In various embodiments, σ(m)=(σ₁(m), . . . , σ_{D}(m)) Argsort(m) such that m_{σ}_{₁}₍ₘ₎≥m_{σ}_{₂}₍ₘ₎≥ . . . ≥m_{σ}_{_{D}}₍ₘ₎. The set of features sorted by MI may be denoted as x_{σ(m)}.

In various embodiments, step 310 includes dropping all features that have an MI value below a threshold γ. Additionally or alternatively, step 310 may include limiting the number of screened features to be at most n_{screen}. For example, step 310 may include dropping all features that have an MI value below 0.1 and limiting the number of screened features to be less than or equal to 20. In various embodiments, the final set of screened features z∈R^{d} may be represented as:

$$z = {x}_{I}$$

where I={i∈{1, . . . , D}:m_{σ}_{ᵢ}₍ₘ₎≥y and i≤n_{screen}. In some embodiments, kernel density estimation is used to estimate ML values.

In some embodiments, method 300 includes calculating a measure of structural complexity. For example, method 300 may include determining structural complexity as:

$$C ( f ) = K ( f ) {log}_{2} B ( f )$$

where K(ƒ) is the number of times the basis function are used in the expression, B(ƒ) is the number of basis functions appearing in ƒ. For example, the expression

$$f ( x ) = 0.5 \times {x}_{1} \times {x}_{2}^{2}$$

may be represented as

$$C = ( 0.5 \times {x}_{1} \times {x}_{2}^{2} ) = 5 {log}_{2} ( 4 ) = 10.$$

At step 320, method 300 may include generating a set of nonlinear features by recursively applying functional and/or algebraic operations (collectively referred to as operators, where [symbol] is the operator set which includes unary operators o[zᵢ] and binary operators o[zᵢ, zⱼ]) to the set of screened features z∈ [symbol] ^{d}. The operator set [symbol] may include any (computable) basis functions, such as dilogarithm functions, Bessel functions, and/or custom binary operators. For example, the operator set [symbol] may include:

$$𝒪 [ {z}_{i} , {z}_{j} ] = \{ I ( {z}_{i} ) , {z}_{i} + {z}_{j} , {z}_{i} - {z}_{j} , {z}_{i} , \frac{{z}_{i}}{{z}_{j}} , exp ( {z}_{i} ) , log ( {z}_{i} ) , \sqrt{{z}_{i}} , {z}_{i}^{- 1} , {z}_{i}^{2} \}$$

where I is the identity operator, exp is the exponential operator, and log is the logarithm operator. In various embodiments, φᵢ(x)∈ [symbol] ^{d}^{ₗ} is the vector of features at the l^{th} level of expansion with total number of elements equal to dₗ (which is a function of the original feature vector x). In various embodiments, method 300 includes generating the feature vectors by recursively applying the operator to combinations of the features at the previous level:

$${ϕ}_{l} ( x ) = \{ 𝒪 [ {z}_{i} ( x ) , {z}_{j} ( x ) ] , ∀ {z}_{i} ( x ) , {z}_{j} ( x ) ∈ {ϕ}_{l - 1} ( x ) \} with {ϕ}_{0} ( x ) = z ( x ) .$$

In various embodiments, for mᵤ unary operators and m_{b} nonsymmetric binary operators, the number of features at level l>0 can be represented as:

$${d}_{l} = {m}_{u} {d}_{l - 1} + {m}_{b} {d}_{l - 1} ( {d}_{l - 1} - 1 ) , {d}_{0} = d$$

In various embodiments, for a given level l, method 300 represents the set of possible functions as linear combinations of the nonlinearly expanded features φₗ^{T}(x)cₗ where cₗ [symbol] ^{d}^{ₗ} a vector of coefficients. In some embodiments, a constant feature (of all ones) is included in φ₁(x) that serves as the bias term.

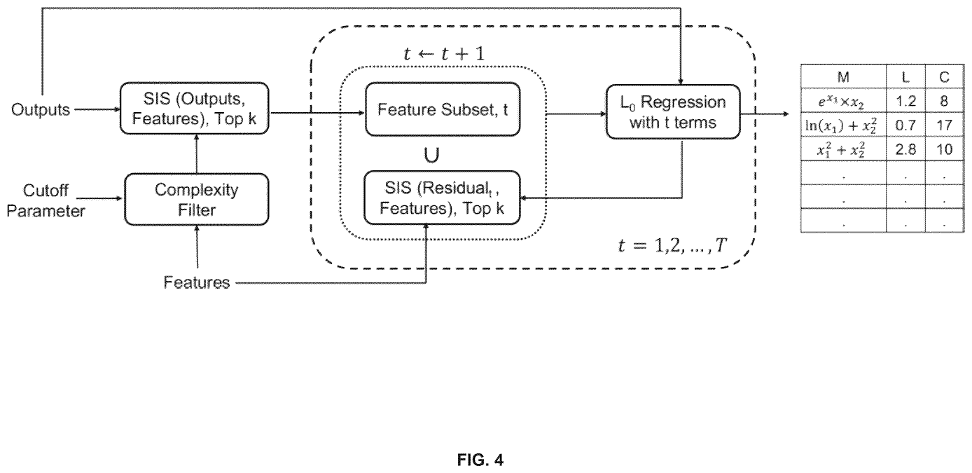

At step 330, method 300 may include generating a model by exploring a combination of features from a pool φₗ(x) at a given expansion level l. In various embodiments, complexity is measured as the zero norm ∥cₗ∥₀ that is directly equal to the number of nonzero coefficients. In various embodiments, step 330 includes computing:

$$( ℳ , ℒ , 𝒞 ) = function ( y , Φ , λ )$$

where y=(y₁, . . . , yₙ)∈ [symbol] ⁿ is an input of training outputs, Φ)∈ [symbol] ^{n×d} is a feature matrix (e.g., corresponding to all d features evaluated at the training inputs, etc.), and λ is a parameter greater than or equal to zero. In various embodiments, the function returns the set of all tested models [symbol] with corresponding loss [symbol] and complexity values [symbol] . Step 330 is described in greater detail with reference to FIG. 4.

At step 340, method 300 may include identifying hyperparameters. In various embodiments, step 340 is automated. The hyperparameters may include the number of expansion levels l and the complexity constraint λ. A brief summary of hyperparameters is given below:

| Parameter | Description |
|---|---|
| Operator set [symbol] | [symbol] may control the space of functions |
| | that are recovered. |
| n_{screen} and γ | n_{screen} and γ may control feature selection |
| | during expansion. n_{screen} may specify the |
| | maximum number of features retained for |
| | regression (e.g., 20, etc.) and γ may be the |
| | mutual information threshold for feature |
| | viability (e.g., 0.1). |
| k (SIS features) | k may determine the number of features |
| | retained in the SIS procedure (e.g., 20, etc.). |
| T (model terms) | T may determine the maximum number of |
| | terms in the final model (e.g., 3, etc.). |
| n_{comp} (complexity thresholds) | n_{comp} may determine the number of |
| | complexity thresholds to test (e.g., 4, etc.). |
| nₑₓₚ (complexity thresholds) | nₑₓₚ may determine the maximum |
| | expansion depth (e.g., 3, etc.). |

At step 340, method 300 may include sequentially looping over a number of these parameters:

$$( {ℳ}_{c , l} , {ℒ}_{c , l} , {𝒞}_{c , l} ) = function ( y , {Φ}_{l} , {λ}_{c} ) ,$$

$$∀ ( c , l ) ∈ \{ 1 , ... , {n}_{comp} \} \times \{ 1 , ... , {n}_{exp} \}$$

where c represents the complexity constraint parameter and l represents the expansion level (e.g., with total number of n_{comp} and nₑₓₚ). In various embodiments, values of {λ₁, . . . , λₙ_{_{comp}}} are generated based on the range of feature complexity determined for a given level. Step 340 may include selecting subsequent λ_{c} values so that they retain the 1−(c−1)/n_{comp} fraction of the least complex features for c>1. In various embodiments, step 340 includes mapping (c,l) to an index i=c+n_{comp}(l−1). In various embodiments, [symbol] ₀=0 is an initial approximation of the Pareto frontier between model loss and complexity and method 300 includes updating the approximation at each iteration:

$${𝒫}_{i} = Update\_Pareto ( {𝒫}_{i - 1} , {ℳ}_{c ( i ) , l ( i )} , {ℒ}_{c ( i ) , l ( i )} , {𝒞}_{c ( i ) , l ( i )} ) ,$$

$$∀ i ∈ \{ 1 , ... , {n}_{exp} {n}_{comp} \}$$

where Update_Pareto(·) determines how the previous Pareto [symbol] ᵢ₋₁ should be updated given the newly determined loss and complexity values from step 330 at iteration i. In some embodiments, a stopping criteria is used to stop if a loss threshold is met (e.g., terminate at iteration i<nₑₓₚn_{comp}. In some embodiments, systems and methods of the present disclosure evaluate performance/complexity for a limited number of models

$$( e . g . , {n}_{exp} {n}_{comp} {\sum }_{t = 1}^{T} ( \begin{matrix}tk \\ t\end{matrix} ) ) .$$

In various embodiments, variables T, k, nₑₓₚ, and n_{comp} are determined to select a balance of accuracy and computational time (e.g., T=3, k=20, nₑₓₚ=3, and n_{comp}=4, etc.). In some embodiments, systems and methods of the present disclosure use parallel computing to reduce an amount of time required to determine a loss and/or complexity of a model.

Referring now to FIG. 4, method 400 for generating a symbolic expression for a set of tested models is shown, according to an exemplary embodiment. In various embodiments, method 400 implements step 330 of method 300 (e.g., function).

In various embodiments, method 400 includes removing features with complexity larger than λ. \tilde{Φ}=Φₗ, may represent the resulting submatrix of Φ generated by extracting its columns corresponding to indices l={1≤i≤d:C(φᵢ(x))≤λ}. In various embodiments, method 400 includes applying sure independence screening (SIS) to identify a subset of features that are correlated with the output: [symbol] =SIS(y,Φ).

In various embodiments, method 400 includes fitting models using linear regression given a subspace of the reduced-complexity feature matrix \tilde{Φ}ₛ∈ [symbol] ^{n×k} In various embodiments, fitting the models includes sequentially generating models from one to a maximum number of terms T, each time using the residual to guide an enlargement of the subspace. rₜ∈ [symbol] ⁿ may represent the residual error for a t-term linear model (i.e., a model with t nonzero coefficients) selected from a features subspace [symbol] ₜ. In some embodiments, a closed-form expression of the error is determined as rₜ=y− [symbol] Eₜcₜ where Eₜ∈ [symbol] ^{k×t} is a binary matrix that selects t feature columns out of the available feature space and

$${c}_{t} = {( {E}_{t}^{T} {\tilde{Φ}}_{{𝒮}_{t}}^{T} {\tilde{Φ}}_{{𝒮}_{t}} {E}_{t} )}^{T} {E}_{t}^{T} {\tilde{Φ}}_{{𝒮}_{t}}^{T} y$$

is the coefficient vector generated as the least-squares solution from fitting [symbol] Eₜ to y. In various embodiments, the recursive construction of the feature space is represented as:

$${𝒮}_{t + 1} = {𝒮}_{t} ⋃ SIS ( {r}_{t}^{*} , \tilde{Φ} ) ,$$

$$∀ t = 1 , ... , T - 1 with {𝒮}_{1} = SIS ( y , \tilde{Φ} )$$

where

$${r}_{t}^{*}$$

is the residual error of the best model tested with t terms from the subspace [symbol] ₜ. In various embodiments, generating

$${r}_{t}^{*}$$

includes applying l₀ regression. For example, method 400 may include training all possible t term models out of the reduced feature space

$$( o ( \begin{matrix}tk \\ t\end{matrix} ) models )$$

and finding the one with the lowest residual error. In various embodiments, method 400 reduces computational costs associated with conventional methods and/or improves computational scalability. For example, method 400 may improve computational scalability (e.g., to feature spaces of 10¹⁰ or more, etc.) by using matrix-vector multiplication rather than training a separate regression model for each feature (e.g., as in forward/backward feature selection, etc.). In various embodiments, systems and methods of the present disclosure generate expressions that are sparse linear combinations of expanded features by recursively applying all operators in O to combinations of the screened primary features.

In various embodiments, systems and methods of the present disclosure facilitate handling multiple outputs. For example, one or more steps of method 300 may be applied to each output independently. In various embodiments, given a data set with m outputs {y⁽¹⁾, y⁽²⁾, . . . , y^{(m)}}, systems and methods of the present disclosure may determine m separate single-output regression problems. For example, for each output y⁽ⁱ⁾, the model may be learned as:

$${y}^{( i )} \approx {ϕ}_{L ( i )}^{T} ( x ) {c}_{L ( i )}^{( i )}$$

where

$${‖ {c}_{L}^{( i )} ‖}_{0} \leq T , {L}^{( i )} \leq {n}_{exp}$$

is the largest expansion level explored for the ith output.

In various embodiments, systems and methods of the present disclosure facilitate handling dynamical systems of the form ż(t)=ƒ(z(t)), where z(t)=[z₁(t), z₂(t), . . . , z_{q}(t)]^{T}∈ [symbol] ^{q} denotes the system's state at time t, and ƒ: [symbol] ^{q}→ [symbol] ^{q} specifies the dynamic constraints. In various embodiments, systems and methods of the present disclosure operate on a time-history of state measurements z(t) and their derivatives ż(t).

The entirety of appendices A and B of U.S. Provisional Patent Application No. 63/723,938, filed on Nov. 22, 2024, are incorporated by reference herein. Systems and methods of the present disclosure may improve the technological field of modeling data/systems. For example, appendices A and B (referenced above) may illustrate reductions in computational load and/or improvements in modeling accuracy facilitated by systems and methods of the present disclosure.

Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure.

The order or sequence of any process or method steps may be varied or re-sequenced according to alternative implementations. Other substitutions, modifications, changes, and omissions may be made in the design, operating conditions, and arrangement of the implementations without departing from the scope of the present disclosure. The present disclosure contemplates methods, systems, and program products on any machine-readable media for accomplishing various operations.

The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general purpose or special purpose computer or other machine with a processor.

By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Throughout the description and claims of this specification, the word “comprise” and variations of the word, such as “comprising” and “comprises,” means “including but not limited to,” and is not intended to exclude, for example, other additives, components, integers or steps.

“Exemplary” means “an example of” and is not intended to convey an indication of a preferred or ideal implementation. “Such as” is not used in a restrictive sense, but for explanatory purposes. Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What is claimed is:

1. A method for modeling data, the method comprising:
receiving a dataset comprising a plurality of input sets and a plurality of outputs each corresponding to an input set of the plurality of input sets, wherein the plurality of input sets are related to the plurality of outputs by a function;
receiving an operator set comprising at least one of (i) an algebraic operator, (ii) a transcendental function, (iii) a constant function, or (iv) an identity function;
reducing the dataset by removing an input from an input set of the plurality of input sets to produce a reduced dataset;
generating, based on the reduced dataset, an expanded feature set;
generating, based on the expanded feature set and a complexity parameter, a set of models, wherein each model of the set of models is associated with a complexity value and a loss value; and
updating the complexity parameter and the expanded feature set.

2. The method of claim 1, wherein reducing the dataset includes computing:
$$MI ( y ; {x}_{i} ) = \int p ( {x}_{i} , y ) log ( \frac{p ( {x}_{i} , y )}{p ( {x}_{i} ) p ( y )} ) dxdy$$
where p(xᵢ,y) is a joint probability density function between the input set (xᵢ) and an output (y) corresponding to the input set, p(xᵢ) is a marginal distribution for the input set (xᵢ), and p(y) is a marginal distribution for the output (y).

3. The method of claim 1, further comprising generating, based on the set of models, a Pareto frontier with respect to the complexity value and the loss value associated with each model of the set of models.

4. The method of claim 3, further comprising:
identifying a Pareto frontier from a plurality of Pareto frontiers, wherein the identified Pareto frontier is closer to utopia than any other Pareto frontier of the plurality of Pareto frontiers; and
transmitting a set of models associated with the identified Pareto frontier.

5. The method of claim 3, further comprising iteratively updating the complexity parameter and the expanded feature set until a condition associated with the Pareto frontier has been satisfied.

6. The method of claim 1, wherein the complexity parameter is updated based on at least one of the complexity value or the loss value associated with each model of the set of models.

7. The method of claim 1, wherein the expanded feature set is updated based on at least one of the complexity value or the loss value associated with each model of the set of models.

8. A system for modeling data, comprising:
a processor; and
memory having instructions stored thereon that, when executed by the processor, cause the processor to:
receive a dataset comprising a plurality of input sets and a plurality of outputs each corresponding to an input set of the plurality of input sets, wherein the plurality of input sets are related to the plurality of outputs by a function;
receive an operator set comprising at least one of (i) an algebraic operator, (ii) a transcendental function, (iii) a constant function, or (iv) an identity function;
reduce the dataset by removing an input from an input set of the plurality of input sets to produce a reduced dataset;
generate, based on the reduced dataset, an expanded feature set;
generate, based on the expanded feature set and a complexity parameter, a set of models, wherein each model of the set of models is associated with a complexity value and a loss value; and
update the complexity parameter and the expanded feature set.

9. The system of claim 8, wherein reducing the dataset includes computing:
$$MI ( y ; {x}_{i} ) = \int p ( {x}_{i} , y ) log ( \frac{p ( {x}_{i} , y )}{p ( {x}_{i} ) p ( y )} ) dxdy$$
where p(xᵢ,y) is a joint probability density function between the input set (xᵢ) and an output (y) corresponding to the input set, p(xᵢ) is a marginal distribution for the input set (xᵢ), and p(y) is a marginal distribution for the output (y).

10. The system of claim 8, wherein the instructions further cause the processor to generate, based on the set of models, a Pareto frontier with respect to the complexity value and the loss value associated with each model of the set of models.

11. The system of claim 10, wherein the instructions further cause the processor to:
identify a Pareto frontier from a plurality of Pareto frontiers, wherein the identified Pareto frontier is closer to utopia than any other Pareto frontier of the plurality of Pareto frontiers; and
transmit a set of models associated with the identified Pareto frontier.

12. The system of claim 10, wherein the instructions further cause the processor to iteratively update the complexity parameter and the expanded feature set until a condition associated with the Pareto frontier has been satisfied.

13. The system of claim 12, wherein the complexity parameter is updated based on at least one of the complexity value or the loss value associated with each model of the set of models.

14. The system of claim 12, wherein the expanded feature set is updated based on at least one of the complexity value or the loss value associated with each model of the set of models.

15. A non-transitory computer-readable storage medium having instructions stored thereon that, when executed by a processor, cause the processor to:
receive a dataset comprising a plurality of input sets and a plurality of outputs each corresponding to an input set of the plurality of input sets, wherein the plurality of input sets are related to the plurality of outputs by a function;
receive an operator set comprising at least one of (i) an algebraic operator, (ii) a transcendental function, (iii) a constant function, or (iv) an identity function;
reduce the dataset by removing an input from an input set of the plurality of input sets to produce a reduced dataset;
generate, based on the reduced dataset, an expanded feature set;
generate, based on the expanded feature set and a complexity parameter, a set of models, wherein each model of the set of models is associated with a complexity value and a loss value; and
update the complexity parameter and the expanded feature set.

16. The non-transitory computer-readable storage medium of claim 15, wherein reducing the dataset includes computing:
$$MI ( y ; {x}_{i} ) = \int p ( {x}_{i} , y ) log ( \frac{p ( {x}_{i} , y )}{p ( {x}_{i} ) p ( y )} ) dxdy$$
where p(xᵢ,y) is a joint probability density function between the input set (xᵢ) and an output (y) corresponding to the input set, p(xᵢ) is a marginal distribution for the input set (xᵢ), and p(y) is a marginal distribution for the output (y).

17. The non-transitory computer-readable storage medium of claim 15, wherein the instructions further cause the processor to generate, based on the set of models, a Pareto frontier with respect to the complexity value and the loss value associated with each model of the set of models.

18. The non-transitory computer-readable storage medium of claim 15, wherein the instructions further cause the processor to:
identify a Pareto frontier from a plurality of Pareto frontiers, wherein the identified Pareto frontier is closer to utopia than any other Pareto frontier of the plurality of Pareto frontiers; and
transmit a set of models associated with the identified Pareto frontier.

19. The non-transitory computer-readable storage medium of claim 18, wherein the instructions further cause the processor to iteratively update the complexity parameter and the expanded feature set until a condition associated with the Pareto frontier has been satisfied.

20. The non-transitory computer-readable storage medium of claim 19, wherein the complexity parameter is updated based on at least one of the complexity value or the loss value associated with each model of the set of models.
